(19) United States
(12) Patent Application Publication
(10) Pub. No.: US 2004/0050643 A1
(43) Pub. Date: Mar. 18, 2004

(54) Clutch actuator

(76) Inventors: Richard M. Krzesicki, Ann Arbor, MI (US); Clive McKenzie, Southfield, MI (US); Gregory J. Stout, Ann Arbor, MI (US); Dennis Cook, Royal Oak, MI (US); Loren C. MacKlem, Berkley, MI (US)

Correspondence Address: Dickinson Wright PLLC, Suite 800, 1901 L. Street NW, Washington, DC, 20036, US

(21) Appl. No.: 10/241,912

(22) Filed: Sep. 12, 2002

(51) Int. Cl. F16D 23/14

(52) U.S. Cl. 192/70.23; 192/84.6; 192/84.7; 192/84.91; 192/94

(57) ABSTRACT

The present invention is directed to a clutch actuator assembly for a clutch pack wherein the clutch actuator assembly includes a lever rotatable about an axis, a drive mechanism that selectively rotates the lever about the axis, and a translating mechanism that receives input from the lever, converts the input to linear displacement, and is operably coupled to the clutch pack pressure plate to apply the linear displacement. The present invention is further directed to a clutch assembly and torque transferring mechanism having such a clutch actuator assembly.

### BACKGROUND OF THE INVENTION

The present invention relates to an actuator for a clutch and, more particularly, to a clutch actuator for transferring rotation and torque from an input shaft to an output shaft.

Clutches are often used in motor vehicles to selectively transfer rotational power from an input shaft to an output shaft. Clutches are typically found in automatic transmissions, differentials, and transfer cases in order to selectively transfer all or a portion of the rotational energy from an input shaft to an output shaft.

Commonly used clutch actuators include hydraulic actuators that use a pump driven by the engine. The pump sends the fluid (e.g., oil) to a thrust mechanism that converts the fluid pressure into a force applied to the clutch pack, causing the clutch pack to engage. Typically, the thrust mechanism is a simple piston, pressure plate, or the like. Notwithstanding the widespread acceptance of hydraulic clutch actuators, it is noted that the piston can be difficult to precisely control, is susceptible to leaks, and is expensive. Hydraulic actuators also have long response times and the pump creates a continuous load on the motor, thereby reducing fuel economy. A variation of hydraulic actuators uses an electric pump instead of a pump driven by the engine. While the electric pump eliminates the continuous load on the motor and improves fuel economy, it retains many of the other concerns of traditional hydraulic actuators.

Conventional clutch actuators may also include an electric motor to apply pressure to the clutch pack. Such systems commonly include a mechanism such as a ball ramp disposed between the motor output and clutch pack to transfer the rotational torque from the motor to a linear force and apply pressure to the clutch pack. One problem with conventional electric motor actuated clutch arrangements is that to provide enough pressure to engage the clutch pack, the motor must be relatively large. As the size of the actuator motor increases, so do the physical space requirements, expense, and weight. Attempts have been made in the art to provide actuator assemblies having the capacity to exert sufficient force on the clutch pack in a controllable and maintainable manner while not requiring undue space or expense. However, the need still exists for improvements in this area.

### SUMMARY OF THE INVENTION

The present invention is directed to a clutch actuator assembly for a clutch pack wherein the clutch actuator assembly includes a lever rotatable about an axis, a drive mechanism that selectively rotates the lever about the axis, and a translating mechanism that receives input from the lever, converts the input to linear displacement, and is operably coupled to the clutch pack pressure plate to apply the linear displacement. The present invention is further directed to a clutch assembly and torque transferring mechanism having such a clutch actuator assembly.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a side elevational view of a torque transferring unit cut away to show internal components;

FIG. 2 is an exploded perspective view of the torque transferring unit;

FIG. 3 is a front elevational view of the hollow ball screw;

FIG. 4 is a side elevational view of the secondary ball screw with lever arm;

FIG. 5 is a front elevational view of the secondary ball screw, with lever arm in hidden lines to show movement; and

FIG. 6 is a side elevational view of an alternative embodiment.

### DETAILED DESCRIPTION OF THE PREFERRED EMBODIMENT

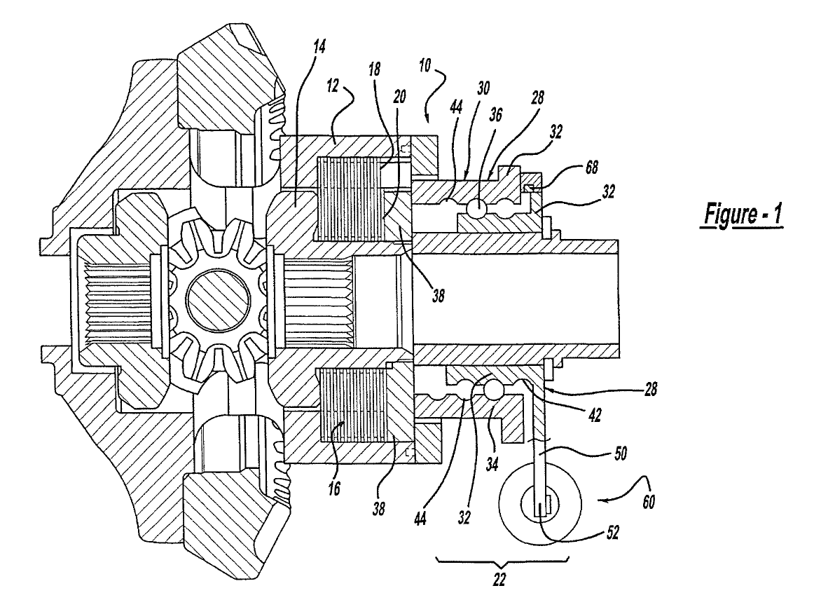

A clutch assembly 10 constructed in accordance with the invention is illustrated in FIG. 1. In general, the clutch assembly 10 is configured to selectively transfer rotational movement and torque from an input member 12 to an output member 14. As is conventional, the clutch assembly 10 includes a clutch pack 16 having first clutch plates 18 fixed to rotate with the input member and interleaved with second plates 20 fixed to rotate with the output member 14. The clutch pack 16 also includes a pressure plate 38 operably coupled to the interleaved plates to impart a force that compresses the plates and transmits torque between the input and output members.

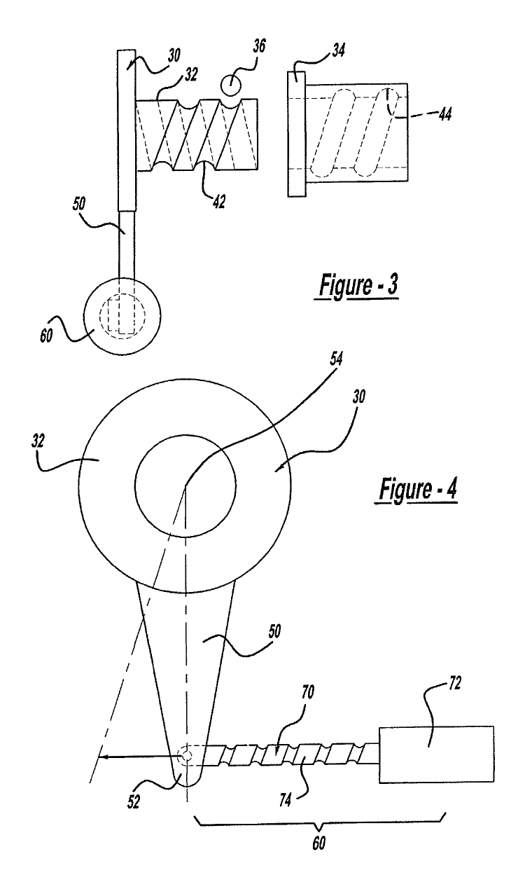

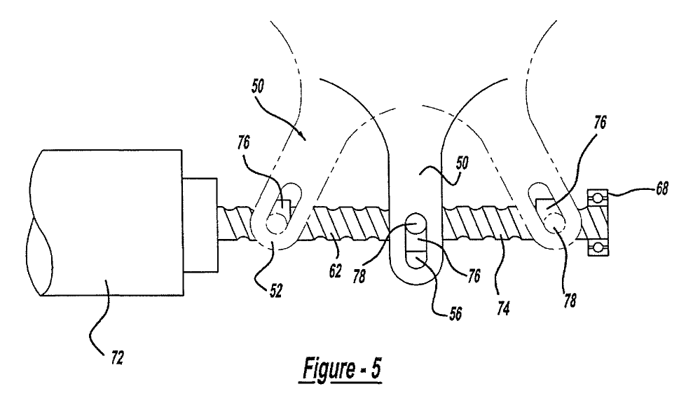

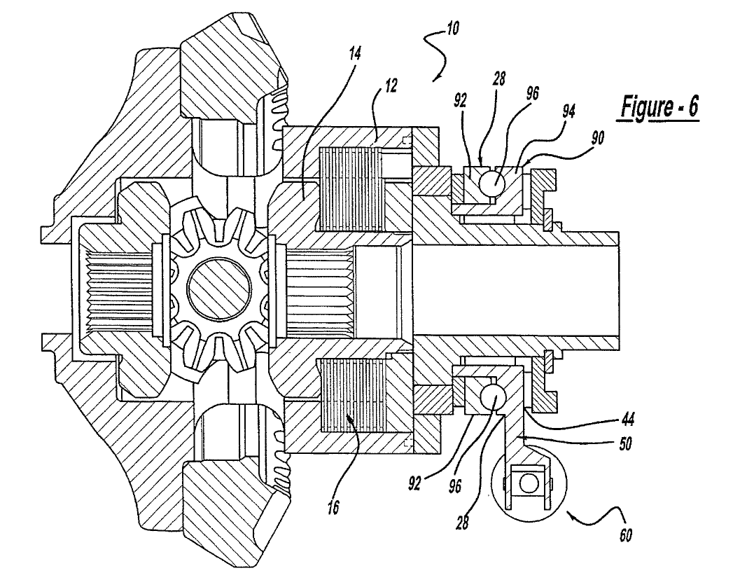

Clutch assembly 10 includes a clutch actuator assembly 22 that controls the position of the pressure plate 38 relative to the interleaved clutch plates. In the illustrated embodiment, the clutch actuator assembly 22 includes a translating mechanism 28, lever 50, and drive mechanism 60. The drive mechanism 60 is coupled to the lever 50, such as at lower end 52, and is controlled in a manner known in the art to selectively rotate the lever 50 about an axis 54 (FIG. 4). The translating mechanism 28 has an input member coupled to rotate with the lever 50 and an output member operably connected to the pressure plate 38 so that rotation of the lever 50 changes the actuation force exerted by the pressure plate on the interleaved clutch plates. In the embodiment of the invention illustrated in FIGS. 1-5, the translating mechanism 28 is shown as a ball screw 30. However, those skilled in the art will appreciate that other mechanisms capable of receiving a rotational input and providing a linear output may be used with the present invention, including the ball ramp configuration shown in FIG. 6.

The structure and arrangement of the clutch assembly components, including the ball screw 30 and lever 50, provide numerous advantages over conventional clutch actuator assemblies. For example, the actuator assembly provides a mechanical advantage permitting greater and controllable forces upon the clutch pack while minimizing the required size of the drive mechanism 60, including the drive motor. Moreover, the use of a ball screw provides a controllable and maintainable pressure on the clutch pack, including active and precise control over the force exerted upon the clutch pack. The controllability of the clutch assembly reduces the response time of the actuator and control over the clamping forces. While a representative illustration of the clutch assembly component is provided below, those skilled in the art will appreciate that various modifications may be made to the illustrated embodiments without departing from the scope of the invention defined by the appended claims.

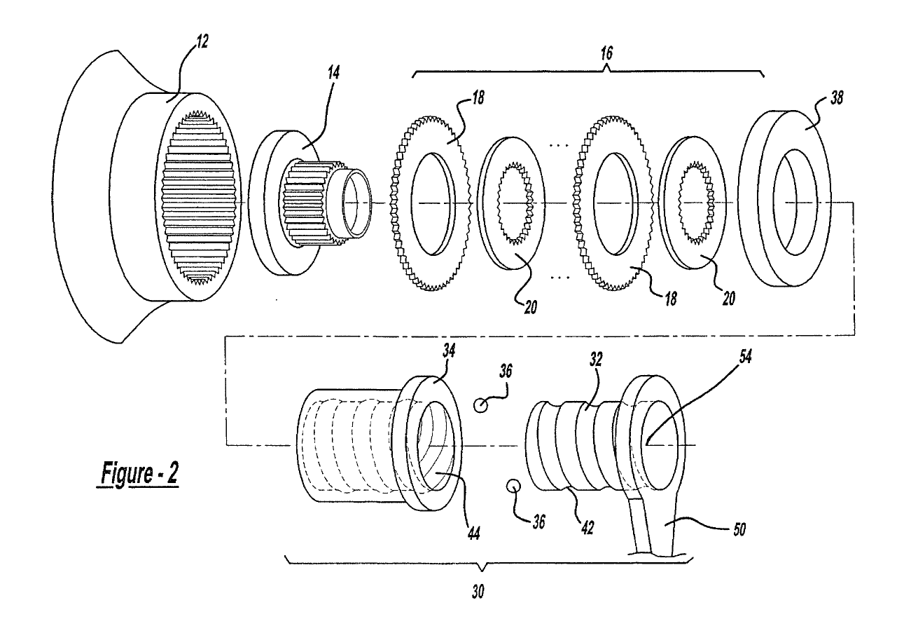

The ball screw 30 acts as the translating mechanism 28 in the embodiment shown in FIGS. 1-5 and converts rotational movement to linear movement with force magnification. The ball screw 30 is shown to include a cylindrical screw sleeve 32, a nut 34, and ball bearings 36. The bearings 36 ride in opposed and facing helical threads or grooves 42 and 44 (FIG. 2) formed in the sleeve 32 and nut 34, respectively. The grooves or threads 34 in the sleeve 42 and nut 44 define a helical path for the bearings 36, such that rotational movement of the lever 50 and sleeve 32 creates linear movement of the nut 34. The nut operatively engages the pressure plate 38 such that the compressive force within the clutch pack changes with linear movement of the nut 34.

Use of a ball screw 30 in the translating mechanism 28 provides specific advantages in the clutch assembly. The shape and pitch of the ball screw grooves or threads 42 and 44 may be varied to tailor the mechanical advantage provided by the ball screw 30 to a particular application. The ball screw 30 provides smooth, consistent and controllable pressure to the clutch pack 20, while the ball bearings 36 and grooves 42 and 44 effectively transfer rotational movement of the sleeve 32 to linear displacement of the nut 34 and minimize friction losses. Further, by using many small ball bearings 36, a relatively high load may be applied to the clutch pack without deforming the ball bearings 36. The specific configuration of the helical grooves 42 and 44 (e.g. pitch and size) may be tailored to provide the desired mechanical advantage based on the amount of pressure needed to be applied to the clutch pack as well as the configuration and capacity of other clutch actuator components, most notably the length of the lever 50 and capacity of the drive mechanism 60.

Those skilled in the art will appreciate that the illustrated embodiment of the ball screw 30 and lever 50 may be varied without departing from the scope of the invention defined by the appended claims. For example, while the first ball screw nut 32 is illustrated as being radially outward of the sleeve 32, packaging and/or operational concerns in some applications may be better addressed by positioning the nut radially inward of the sleeve 32.

In the embodiment shown in FIGS. 1-5, the ball screw sleeve 32 is integral with the lever arm 50. Of course the lever arm 50 may be attached to the ball screw sleeve 32 by a variety of means such as welding, bonding, or a fastener. The length of the lever arm 50 provides the mechanical advantage for rotating the ball screw sleeve 32, provides flexibility in the positioning of the drive mechanism 60, and may be formed in a variety of shapes or configurations, with the length depending on the desired mechanical advantage and packaging constraints.

The lever arm 50 is rotated by the controlled movement of the drive mechanism 60. As is shown in FIGS. 4 and 5, the drive mechanism 60 has an output 62 pivotally coupled to the lever 50 proximate the lever end 52. In some instances, the lever 50 may be provided with an elongated lost motion slot 56 (FIG. 5) to facilitate smooth operation of the lever/drive mechanism connection. The slot 56 can be made in a variety of shapes, sizes, and configurations.

While a variety of drive mechanisms 60 may be used to move the lever arm 50, the drive mechanism 60 is shown to include a secondary ball screw 70 driven by a drive device 72, such as an electric motor. The use of a secondary ball screw 70 enhances the mechanical advantage provided by and controllability of the clutch actuator assembly 22. The secondary ball screw 70 may be formed in a variety of sizes, shapes, and configurations without departing from the spirit of the invention and is shown in FIG. 5 to include a helically threaded or grooved screw shaft 74 and a second ball nut 76 which moves linearly along the shaft as the shaft 74 rotates. A pin 78 on the second ball nut 76 is disposed in the slot 56 on the lever arm 50. The pin 78 slides in the slot 56 as the secondary ball screw 70 moves the lever arm 50, allowing for the radial movement of the lever arm 50 relative to the shaft 74. A radial bearing 68 supports the screw shaft to permit the secondary ball screw 70 to freely rotate while maintaining its position and preventing warping, bending, or unwanted movement. Of course, the second ball nut 76 or secondary ball screw 70 may be fastened directly to the lever as shown in FIG. 4.

As is noted throughout this detailed description, various alternatives to the illustrated embodiments may be used without departing from the scope of the invention. For example, FIG. 6 illustrates the clutch actuator assembly 22 wherein a ball ramp 90 is disposed between the lever arm 50 and the pressure plate 38. While a ball ramp 90 does not provide the actively controllable and maintainable forces to the extent of a ball screw, the alternative illustrates that various known components may be substituted in the present invention. The ball ramp 90 acts as a translating mechanism and includes an inner plate 92 operably coupled to the pressure plate 38, an outer plate 94 coupled to rotate with the lever arm 50, and ball ramp bearings 96. The ball ramp bearings 96 ride in ramps (not shown) in a conventional manner such that rotational movement of the lever 50 and outer plate 94 creates linear movement of the inner plate 92. The specific shape and angle of the ramps may be varied to tailor the mechanical advantage provided by the ball ramp 90 to a particular application. The mechanical advantage of the ball ramp 90, lever 50, and secondary ball screw 90 again allow a small pressure input by the rotational pressure device 72 to be multiplied to a larger pressure applied to the clutch pack 16.

In operation, the torque transferred by the clutch pack 20 is controlled by the linear displacement of the pressure plate 38 which is in turn dictated by the helix angle of the ball screw grooves 42 and 44 and the rotational displacement of the lever 50. In short, the rotational pressure device 72 turns the secondary ball screw shaft 74, which causes the second ball nut 76 to move along the secondary ball screw shaft 74. The pin 78 within the slot 56 on the lever 50 rotationally displaces the lever arm 50 about axis 54. The ball screw sleeve 32 rotates with the lever 50, causing linear displacement of the ball nut 34 and pressure plate 38. The pressure plate 38 in turn applies pressure to the clutch pack 20, which engages the torque transfer unit causing the rotational input shaft 22 to turn in the same direction as the rotational output shaft 24.

The use of a ball screw 30 attached to a lever arm 50 provides a mechanical advantage that allows the use of a less robust drive mechanism 60. The size of the drive mechanism 60 depends on a number of factors including (1) the amount of torque being transmitted across the clutch pack, (2) the number of friction surfaces on the clutch pack, (3) the inside and outside diameter of the clutch plates, (4) the stroke to actuate the clutch pack, (5) the ball screw helix, and (6) the ball screw efficiency.

Those skilled in the art will appreciate that the appropriate size and configuration of the actuator 22 may be determined in a variety of ways. By way of example rather than limitation, determination of an appropriate size actuator may include determining the desired clutch pack clamp force, verifying an acceptable plate interface pressure, calculating the appropriate ball screw input torque, factoring the mechanical advantage of the lever arm, and accounting for the mechanical advantage contribution of the drive mechanism, such as the illustrated secondary ball screw.

The remaining paragraphs of this specification set forth a representative calculation for determining the appropriate size and configuration of the actuator. Those skilled in the art will appreciate that the example is provided for illustration only. In this example, the amount of torque to be transferred across the clutch pack is 32040 in-lbf. The exemplary clutch pack 16 has an outside diameter (D) of 2.800 inches, an inside diameter (d) of 2.00 inches, and sixty frictional surfaces (N). Equation (1) is used to determine the pressure to be applied to the clutch pack 16.

$$P := 3 \cdot T \cdot [ \frac{( {D}^{2} - {d}^{2} )}{N \cdot μ \cdot ( {D}^{3} - {d}^{3} )} ] \cdot sin ( α ) \qquad ( 1 )$$

where the friction coefficient (μ) between clutch plates is 0.10 and the angle (α) on the cone clutch is 90°. Inserting the above values into the equation (1) yields:

$$P := 3 \cdot ( 32040 in \cdot lbf ) \cdot [ \frac{{( 2.800 in )}^{2} - {( 2.00 in )}^{2}}{( 60 ) \cdot ( 0.10 ) \cdot ( {( 2.800 in )}^{3} - {( 2.00 in )}^{3} )} ] \cdot sin ( 90 ) \qquad ( 2 )$$

Therefore, the pressure of the clamp load needed to transfer the required torque across the clutch pack is 4,409 lbf.

The plate interface pressure is commonly calculated during clutch pack design in order to ensure that the calculated clutch pack pressure does not cause excessive wear. Equation (3) may be used to determine plate interface pressure in the representative actuator.

$$Pressure := \frac{P}{[ π \cdot \frac{( {D}^{2} - {d}^{2} )}{4} ]} \qquad ( 3 )$$

This calculation for the representative actuator yields a plate interface pressure of 1462 lbf/in². For the sake of this illustration, it is assumed that a plate interface pressure less than 1,500 psi is acceptable.

The ball screw input torque (Γ) required to create the calculated clutch pack clamp load is determined based on:

$$Γ := β \cdot \frac{P}{2 \cdot π \cdot ϵ} \qquad ( 4 )$$

where, in this exemplary illustration, the ball screw lead (β) is 0.3937 in. and the ball screw efficiency (ε) is 0.90. The above calculation gives a required input torque of 307 in-lbf. This input torque is the direct rotational torque needed to rotate the ball screw 30.

Of course, the lever arm also provides a mechanical advantage. To determine the load (P2) needed to be applied to the lever arm 50, the input torque (Γ) is divided by the radius or length of the lever arm:

$$P2 := \frac{Γ}{Radius} \qquad ( 5 )$$

If the radius of the lever arm is 3.0 inches, the load applied to the lever arm 50 would need to be just over 102 in-lbf.

In the illustrated embodiment, a secondary ball screw 70 is used to apply pressure to the lever arm 50. The secondary ball screw 70 also provides a helix advantage and, as noted above, the amount of input torque to the ball screw may be determined from:

$$MotorTorque := β2 \cdot \frac{P2}{2 \cdot π \cdot ϵ} \qquad ( 6 )$$

where β2 is the secondary ball screw lead, (ε) is the efficiency of the secondary ball screw, and P2 is the amount of load needed to be applied to the lever arm. In the illustrated example, the lead on the secondary ball screw is 0.118 inches and the efficiency is 0.90. Inserting these values into the equation (6) yields a ball screw input torque from the rotational pressure device of approximately 2.135 in-lbf. This example illustrates that the use of two ball screws 30 and 70 as well as a lever 50 allows the use of a much smaller drive device 72 to provide the input torque to engage the clutch pack 16. The advantage of using two ball screws 30 and 70 and a lever arm 50 is significant in that the input torque of 2.135 in-lbf is magnified to exert a clamping load of approximately 4,409 lbf.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A clutch actuator assembly for a clutch pack having a pressure plate, said clutch actuator assembly comprising:
a lever rotatable about an axis;
a drive mechanism coupled to said lever to selectively rotate said lever about said axis; and
a translating mechanism operably coupled to said lever to transfer rotational movement of said lever to linear displacement of the pressure plate.

2. The clutch actuator assembly of claim 1 wherein said translating mechanism has a first member coupled to rotate with said lever and a second member, said second member operably coupled to the pressure plate and being linearly displaced upon rotation of said first member.

3. The clutch actuator of claim 2 wherein said translating mechanism is a ball screw operably interconnecting said lever to the pressure plate.

4. The clutch actuator of claim 3 wherein said ball screw further comprises:
a sleeve having a first helix;
a nut having a second helix operably interconnected with said first helix, whereby said interconnected first helix and second helix magnify the force exerted on the pressure plate relative to the force exerted by the drive mechanism.

5. The clutch actuator of claim 4 wherein said sleeve is coupled to rotate with said lever to define said first member of said translating mechanism and said ball screw nut is operably coupled to the pressure plate to define said second member of said translating mechanism.

6. The clutch actuator of claim 1 wherein said drive mechanism includes a drive device and a secondary translating mechanism connecting said drive device to said lever.

7. The clutch actuator of claim 6 wherein said secondary translating mechanism is a ball screw.

8. The clutch actuator of claim 7 wherein said drive device is an electric motor.

9. The clutch actuator of claim 1 wherein said translating mechanism is a ball ramp operably interconnecting said lever to the pressure plate.

10. A torque transferring mechanism comprising:
an input shaft;
an output shaft;
a clutch pack having first clutch elements rotating with the input shaft and second clutch elements rotating with the output shaft;
a lever rotatable about an axis;
a drive mechanism coupled to said lever to selectively rotate said lever about said axis; and
a translating mechanism having a first member coupled to rotate with the lever and a second member operably coupled to the clutch pack, said second member being connected to said first member such that rotational movement of the first member linearly displaces the second member to change a compressive force exerted on the clutch pack.

11. The torque transferring unit of claim 10 wherein said translating mechanism is a ball screw.

12. The torque transferring unit of claim 11 wherein said ball screw include a sleeve operably interconnected to a nut with a helix whereby said helix magnifies the force exerted on the clutch pack relative to the force exerted by the drive mechanism and wherein one of said sleeve and nut defines said first member of the translating mechanism and the other of said sleeve and nut defines said second member of said translating mechanism.

13. The torque transferring unit of claim 10 wherein said drive mechanism further comprises an electric motor and a secondary ball screw connecting said motor to said lever.

14. The torque transferring unit of claim 13 wherein said drive mechanism further comprises a second ball nut connecting said second ball screw to said lever arm.

15. The torque transferring mechanism of claim 10 wherein said translating mechanism is a ball ramp comprising an inner plate and an outer plate, said inner plate transferring rotational movement of said lever and said outer plate to linear displacement of said clutch pack.
